(19) United States
(12) Patent Application Publication
(10) Pub. No.: US 2015/0058027 A1
(43) Pub. Date: Feb. 26, 2015

(54) Restricting Ratings of Medical Service Providers to Authenticated Users

(71) Applicant: Ali Adel Hussam, Columbia, MO (US)

(72) Inventor: Ali Adel Hussam, Columbia, MO (US)

(21) Appl. No.: 13/973,568

(22) Filed: Aug. 22, 2013

(51) Int. Cl. G06Q 30/02; G06Q 50/22

(52) U.S. Cl. CPC G06Q 30/0282; G06Q 50/22
USPC 705/2

(57) ABSTRACT

A computer-implemented method, comprising: receiving, by a processing device and from a client device associated with a requesting user, a request to provide a health grade rating for a medical service provider who is associated with a health care entity; accessing, in response to the request, an authentication rules engine that restricts submission of health grade ratings to authenticated users of the health care entity; determining, based on execution of the authentication rules engine, that the requesting user is an authenticated user of the health care entity; and in response to determining that the requesting user is authenticated, transmitting, to the client device, information for a graphical user interface that enables the requesting user to submit the health grade rating for the medical service provider.

### BACKGROUND

Social networks and other on-line communities provide different outlets for users of the respective social networks to interact and provide information about what is happening in the life of particular users of the respective social networks.

### SUMMARY

In general, a health care entity is described. In an example, the health care entity can be a system, such as an online patient community, that allows users whom either are contemplating a medical procedure or have already undergone a medical procedure to locate other users that are similarly situated. In an example, a user that has undergone a hip-replacement surgery can locate other users that have undergone the same surgery. The health care entity also allows users of the health care entity to provide one or more ratings about one or more medical service providers that have provided one or more medical services to a particular user. In a particular example, particular users are authenticated before they are allowed to provide the one or more ratings about the one or more medical service providers. These ratings can then be seen by other users of the health care entity (both authenticated and non-authenticated) and the ratings may aid the other users of the health care entity in selecting a service provider for a similar medical procedure. In general, by restricting ratings to only those users that have been authenticated, the quality of ratings can be increased and the other users of the health care entity may be more inclined to use the one or more ratings as part of their decision when selection from multiple medical service providers.

In one aspect of the present disclosure, a computer-implemented method includes receiving, by a processing device and from a client device associated with a requesting user, a request to provide a health grade rating for a medical service provider who is associated with a health care entity; accessing, in response to the request, an authentication rules engine that restricts submission of health grade ratings to authenticated users of the health care entity; determining, based on execution of the authentication rules engine, that the requesting user is an authenticated user of the health care entity; and in response to determining that the requesting user is authenticated, transmitting, to the client device, information for a graphical user interface that enables the requesting user to submit the health grade rating for the medical service provider. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Implementations of the disclosure may include one or more of the following features. In some implementations, the health care entity comprises an online patient community for generating social connections between users of the online patient community; and wherein determining that the requesting user is an authenticated user of the online patient community promotes an increase in a quality of health grade ratings, relative to a quality of health grade ratings that would be provided by unauthenticated users. The medical service provider is a first medical service provider, and wherein the method further comprises: accessing information indicative of health grade ratings for a second medical service provider who is associated with the health care entity, with the health grade ratings for the second medical service provider being provided by first authenticated users who are associated with the health care entity; accessing information indicative of health grade ratings for a third medical service provider who is associated with the health care entity, with the health grade ratings for the third medical service provider being provided by second authenticated users who are associated with the health care entity; and generating, based on a comparison of the health grade ratings for the second medical service and the health grade ratings for the third medical service, an evaluation of the second medical service provider relative to the third medical service provider, with the evaluation specifying strengths of the second medical service provider relative to strengths of the third medical service provider, with the specified strengths being based on the health grade ratings for the second medical service and the health grade ratings for the third medical service. The health grade rating comprises one or more of a patient review, a patient recommendation, a satisfaction rating and an outcome rating; wherein the outcome rating is indicative of a strength of an assessment of one or more of a pre-operative condition, an operative procedure, and a post-operative condition. The health care entity comprises an online patient community, wherein the online patient community comprises medical service providers and users, and wherein the method further comprises: restricting access for submission of health grade ratings for medical service providers who are members of the online patient community to users who are members of the online patient community.

In some implementations, the client device comprises a first client device, and wherein the method further comprises: receiving, from a second client device of a searching user, a request to search for a medical service provider associated with one or more predefined attributes that are specified by the searching user as defining an acceptable medical service provider; identifying, in response to the request to search, a medical service provider that is associated with at least one of the one or more predefined attributes; identifying, for the identified medical service provider, one or more health grade ratings, with the identified one or more health grade ratings being provided by authenticated users of the health care entity; and transmitting, to the second client device, information identifying the identified medical service provider and the identified one or more health grade ratings. The health care entity comprises a hospital, and wherein determining, based on execution of the authentication rules engine, that the requesting user is an authenticated user of the hospital comprises: accessing a data repository that is associated with the hospital; and identifying, in data base records that are accessed through the data repository, information specifying that the requesting user is a patient of the hospital.

In still another aspect of the present disclosure, one or more machine-readable hardware storage devices storing instructions that are executable by one or more processing devices to perform operations comprising: receiving, from a client device associated with a requesting user, a request to provide a health grade rating for a medical service provider who is associated with a health care entity; accessing, in response to the request, an authentication rules engine that restricts submission of health grade ratings to authenticated users of the health care entity; determining, based on execution of the authentication rules engine, that the requesting user is an authenticated user of the health care entity; and in response to determining that the requesting user is authenticated, transmitting, to the client device, information for a graphical user interface that enables the requesting user to submit the health grade rating for the medical service provider. This aspect of the disclosure may include one or more of the foregoing features.

In yet another aspect of the present disclosure, an electronic system includes one or more processing devices and one or more machine-readable hardware storage devices storing instructions that are executable by the one or more processing devices to perform operations comprising: receiving, from a client device associated with a requesting user, a request to provide a health grade rating for a medical service provider who is associated with a health care entity; accessing, in response to the request, an authentication rules engine that restricts submission of health grade ratings to authenticated users of the health care entity; determining, based on execution of the authentication rules engine, that the requesting user is an authenticated user of the health care entity; and in response to determining that the requesting user is authenticated, transmitting, to the client device, information for a graphical user interface that enables the requesting user to submit the health grade rating for the medical service provider. This aspect of the disclosure may include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE FIGURES

FIG. 1 is a block diagram of components of a health care entity.

FIGS. 2-8 are screen images of graphical user interfaces generated by an application that can be used to interface with the online patient community system.

FIG. 9 shows a hand held device executing an application that generates the graphical user interfaces that can be used to interface with the online patient community system.

FIG. 10 is a flow chart of an example process that can be used to prevent unauthenticated users from authoring ratings of medical service providers.

Like reference symbols in the various drawings indicate like elements.

### DETAILED DESCRIPTION

In general, a health care entity is described. In an example, the health care entity can be a system, such as an online patient community, that allows users whom either are contemplating a medical procedure or have already undergone a medical procedure to locate other users that are similarly situated. In an example, a user that has undergone a hip-replacement surgery can locate other users that have undergone the same surgery. The health care entity also allows users of the health care entity to provide one or more ratings about one or more medical service providers that have provided one or more medical services to a particular user. In a particular example, particular users are authenticated before they are allowed to provide the one or more ratings about the one or more medical service providers. Generally, an authenticated user includes a user with a confirmed association with the health care entity. There are various types of associations between the user and the health care entity. One type of association is based on the user having an account with the health care entity, e.g., by having an online account. Another type of association is the user being socially connected (e.g., in a social networking environment) to the health care entity and/or to a provider of the health care entity. These ratings can then be seen by other users of the health care entity (both authenticated and non-authenticated) and the ratings may aid the other users of the health care entity in selecting a service provider for a similar medical procedure. In general, by restricting ratings to only those users that have been authenticated, the quality of ratings can be increased and the other users of the health care entity may be more inclined to use the one or more ratings as part of their decision when selection from multiple medical service providers.

In an example, the medical service providers may be associated with the health care entity. In an example, a health care entity can be a hospital, an online patient community, or some combination of the two, such as an online patient community that is operated by a particular hospital.

In a particular example, the medical service providers may be associated with a particular health care entity as preferred or otherwise recommended medical service providers. In an example where the health care entity is an online patient community, particular medical service providers may be associated with the particular online patient community by having a presence on the particular online patient community, such as being a user of the particular online patient community, providing content on the particular online patient community, and so forth.

In an example where the health care entity is a hospital, the medical service providers have been retained or are otherwise allowed to see patients at the particular hospital. In an example, one or more of the medical service providers may exclusively provide their medical services at the particular hospital. In another example, one or more of the medical service providers may provider their medical services at multiple hospitals.

In an example, the health care entity, such as some combination of an online patient community and a hospital, may include one or more health grade ratings for the service providers that are associated with the health care entity. In a particular example, the health care entity may include an authentication rules engine that can be used to authenticate at least some of users of the online community. Generally, an authentication rules engine includes a series of instructions specifying that only authenticated users are enabled (e.g., allowed) to submit health grade ratings. In general, only authenticated users can provide health grade ratings. In an example, the health care entity may cause graphical user interfaces to be presented on an application that interacts with the health care entity when a particular user operating the application is authenticated.

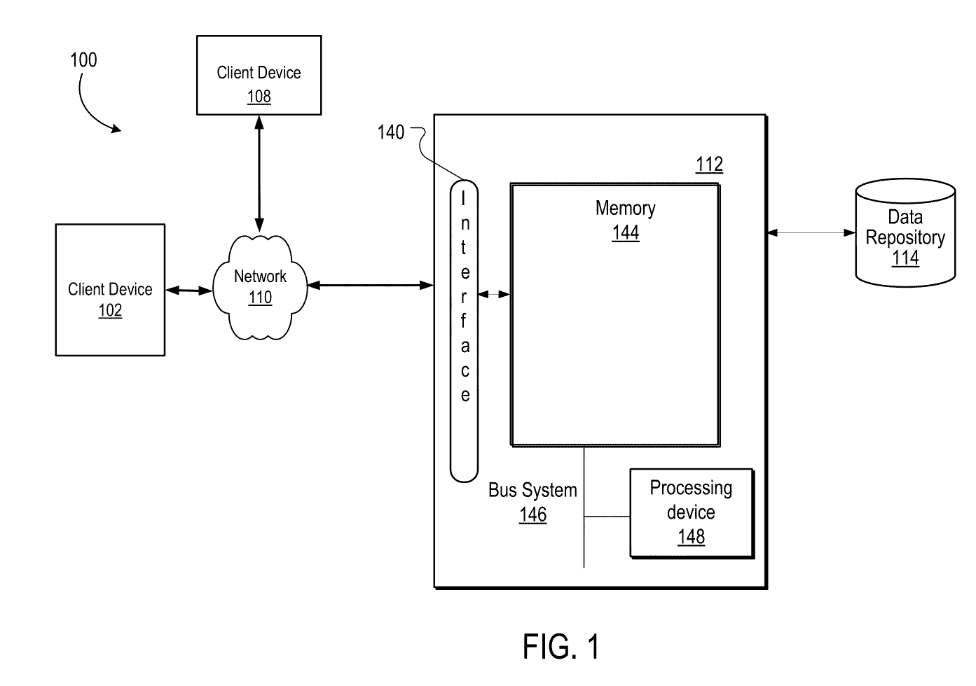

In general, FIGS. 1-9 are described in relation to the collection and use of certain personal medical information of one or more users. The processes and procedures used by health care entity described herein for the collection and use of the personal medical information are compliant with the Health Insurance Portability and Accountability Act (HIPPA) and any other relevant regulations for the protection of personal medical information and other information. In addition, in some implementations, aspects of some or all of the information that is collected by the health care entity can be anonymized to add additional privacy protections for the users of the online patient community system.

FIG. 1 is a block diagram of components of a health care entity system 100 that can be operated by a health care entity. A health care entity can be a hospital, an online patient community, a hospital operating an online patient community, or other combinations. In FIG. 1, client devices 102, 108 can be any sort of computing devices capable of taking input from a user and communicating over network 110 with server 112 and/or with other client devices. For example, client devices 102, 108 can be mobile devices, desktop computers, laptops, cell phones, personal digital assistants (“PDAs”), servers, embedded computing systems, and so forth.

In an example, the client devices 102 and 108 are configured to present one or more graphical users interfaces to their respective users. In a particular example, the client devices 102 and 108 have been installed with an application or other executable code. The application or executable code can cause presentation of the graphical user interfaces when the application or executable code is executed, e.g., by a processing device 148. These graphical user interfaces allow users to enter information and interact with other users of the health care entity system 100 and to provide ratings of one or more medical providers that are associated with the health care entity. Particular examples of graphical user interfaces are described in more detail below.

Server 112 can be any of a variety of computing devices capable of receiving data, such as a server, a distributed computing system, a desktop computer, a laptop, a cell phone, a rack-mounted server, and so forth. Server 112 may be a single server or a group of servers that are at a same location or at different locations.

In general, the server 112 can serve as platform for the health care entity system 100 whereby users can connect with each other and share information related to their recovery status and/or provide ratings and recommendations regarding particular medical service providers. In an example, each of the client devices 102 and 108 can communicate with the server 112 and provide data indicative of a recovery log or other status updates to the server 112.

The illustrated server 112 can receive data from client devices 102, 108 via input/output (“I/O”) interface 140. I/O interface 140 can be any type of interface capable of receiving data over a network, such as an Ethernet interface, a wireless networking interface, a fiber-optic networking interface, a modem, and so forth. Server 112 also includes a processing device 148 and memory 144. A bus system 146, including, for example, a data bus and a motherboard, can be used to establish and to control data communication between the components of server 112.

The illustrated processing device 148 may include one or more microprocessors. Generally, processing device 148 may include any appropriate processor and/or logic that is capable of receiving and storing data, and of communicating over a network (not shown). Memory 144 can include a hard drive and a random access memory storage device, such as a dynamic random access memory, or other types of non-transitory machine-readable storage devices. Memory 144 stores computer programs (not shown) that are executable by processing device 148 to perform the techniques described herein. In a particular example, the memory can store an authentication rules engine that restricts submission of health grate ratings to authenticated users of the health care entity system 100.

In an example, server 112 generates and implements an online patient community, e.g., a social networking platform that enables individual users to establish social connections with other users of the social networking platform. The social connections formed between individual users within a social networking platform may be represented in the form of a graph, where users are represented by nodes and social connections between users are represented by edges connecting the nodes. These social connections between users may reflect relationships between the underlying human users who correspond to the users. For example, a social connection between two users within the online patient community may reflect a social friendship (e.g., developed through physical interaction in the real-world and/or through on-line interaction in the cyber-world) or a professional relationship between the underlying human users who correspond to the users. This social friendship may be based on the two users having similar medical issues, similar prescribed therapies, being interested in similar medical topics, and so forth.

In an example, a user of the online patient community may be able to unilaterally form a social connection with another user of the online patient community, e.g., based on the two users having a same or a similar medical condition. In this example, the online patient community may enable a first user to form a connection to a second user by specifying a desire to form a social connection to the second user and without requiring approval of the connection by the second user. In another example, the formation of social connections between two users may be a bilateral process. In this example, when a first user specifies a desire to form a connection to a second user, the online patient community may establish the connection only after the second user approves the formation of the connection between the first user and the second user.

A user of the online patient community may form an online patient community within the social networking platform by forming social connections to other users of the social networking platform. In some cases, the online patient community of a particular user of a social networking platform may be defined as the group of other users to whom the particular user is directly connected. Alternatively, in other cases, the online patient community of a particular user of a social networking platform may be defined to include a group of other users that are within a threshold number of degrees of separation of the particular user. In an example, a graph or other data structure may be maintained by the social networking platform to describe the degrees of separation between a particular users and other users.

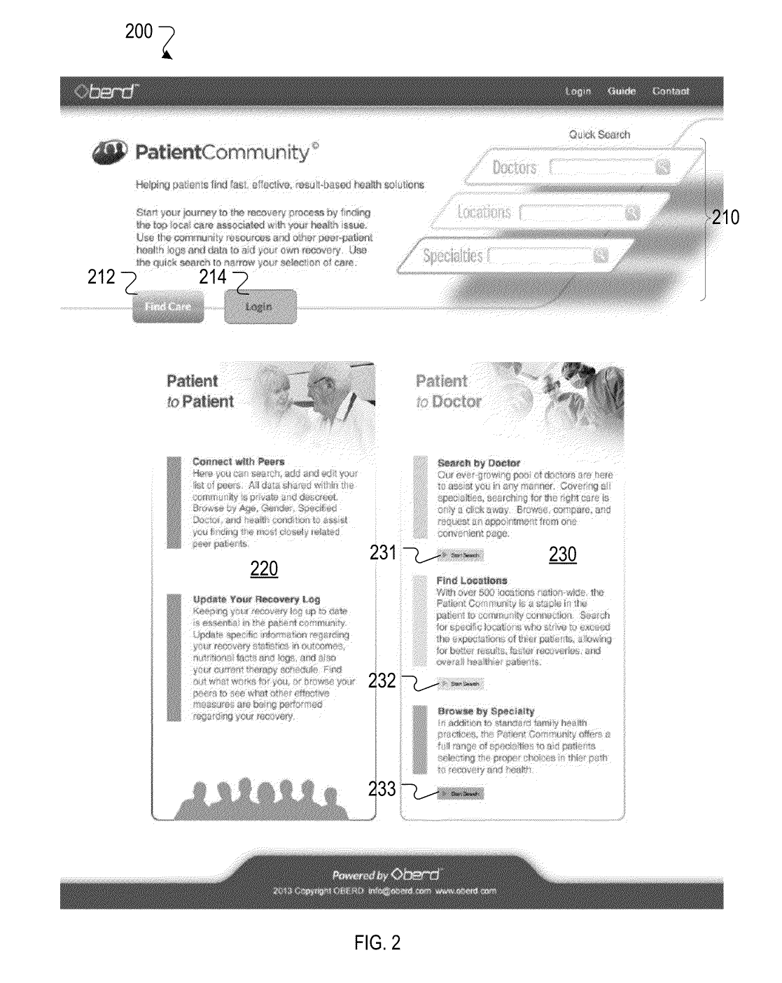

Referring now to FIGS. 2-8, server 112 can generate information for one or more graphical user interfaces that provide information to a user of the health care entity system 100 (FIG. 1). In general, this information can be indicative of various things to aid the user in making informed decisions with respect to their respective medical care. In an example, the information can be indicative of a profile of one or more users of the health care entity system 100 who have undergone a similar procedure. In another example, the information can be indicative of physicians or other service providers that perform the particular procedure. In yet another example, the information can be indicative of a recovery log for a particular user of the health care entity system 100.

In general, the graphical user interfaces can be rendered by an application installed on a client device 102 or 108 (FIG. 1) as part of execution of the application. In an example, the graphical user interfaces can be rendered by an application that when executed generates the graphical user by loading graphical resources stored on the client device 102 or 108 and installed as part of the installation of the application. In another example, the graphical user interfaces can be generated by a browser-based application that generates that graphical user interfaces by receiving and interpreting information indicative of one or more web pages provided by the health care entity system 100.

Referring now to FIG. 2, a screen image of a graphical user interface 200 is shown that may be presented as a home screen or other initial landing screen. In an example, the graphical user interface 200 can be presented when a user first executes an application that can interface with the health care entity system 100 (FIG. 1). In another example, the graphical user interface 200 can be presented when a user navigates to a web page that is provided by the health care entity system 100 (FIG. 1) using a browser-based application.

In a particular example, the graphical user interface 200 includes a quick search region 210, a patient-to-patient region 220, and a patient-to-doctor region 230. The particular example of the graphical user interface 200 also includes “find care” user interface control 212 and a “login” user interface control 214.

The quick search region 210 allows a user to enter certain search criteria related to doctors, locations, and specialties into respective fields of the quick search region 210 to identify medical service providers that match the provide search criteria. A user need not enter information into all fields of the quick search region 210 to obtain search results. In an example, a user can search for doctors by last name only without providing a location or a specialty in the quick search region 210. As a result of providing the search criteria, the health care entity system 100 (FIG. 1) can perform a search to locate one or more medical service providers, such as doctors, hospitals, physical therapists, and other medical service provides that are response to the search request.

The patient-to-patient region 220 presents useful information about the health care entity system 100 (FIG. 1) to a user. This may entice or otherwise convince a user to register with the health care entity system 100. In a particular example, the user may register with the health care entity system 100 using he “login” user interface control 214.

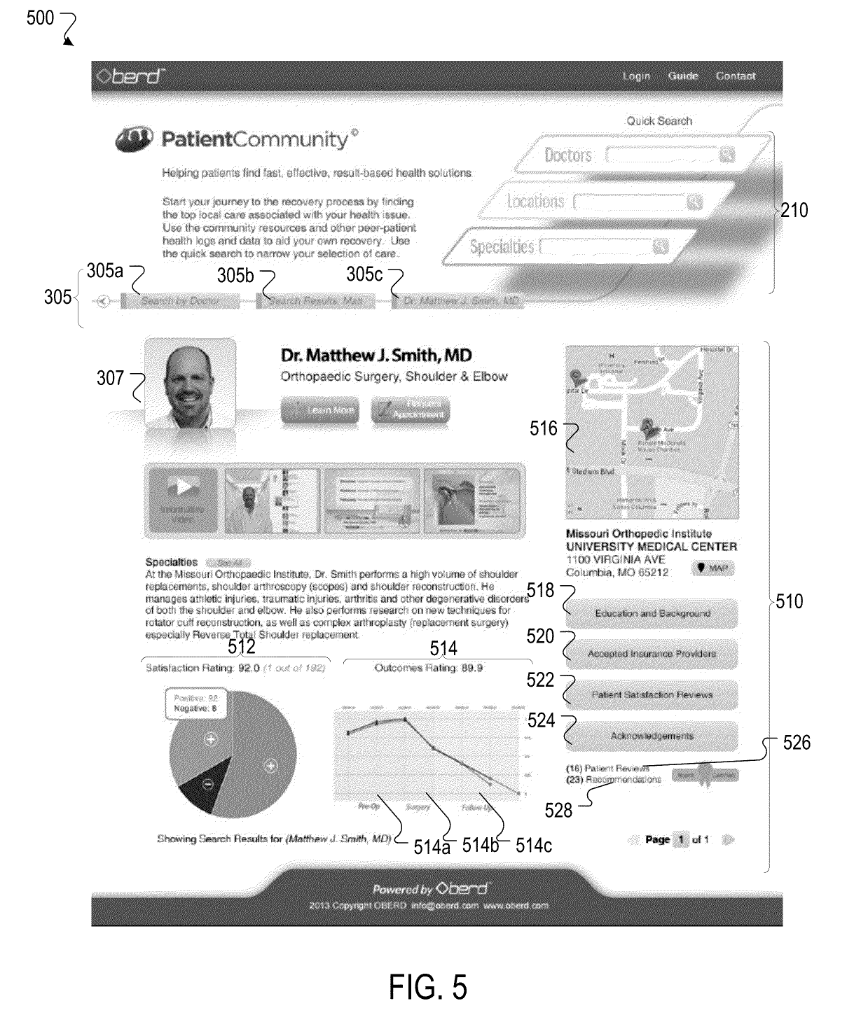

In some implementations, when a user selects the “login” user interface control 214, the application may generate another graphical user interface that allows the user to login into the online patient community system using various login credentials. An example of a graphical user interface that can be used for this purpose is described in more detail in reference to FIG. 5.

The doctor-to-patient region 230 presents useful information to users who are searching for medical service providers. In addition, the doctor-to-patient region 230 presents user interface controls 231, 232, and 233 that when selected perform a particular targeted search. In an example, if a user selects the user interface control 231, the user can perform a search to find a specific doctor. In another example, if a user selects the user interface control 232, the user can perform a search to find a specific location in which to have a medical procedure performed.

In some implementations, when a user selects the “find care” user interface control 212, the application may generate another graphical user interface that allows the user to search for search for medical care by providing one or more pieces of information.

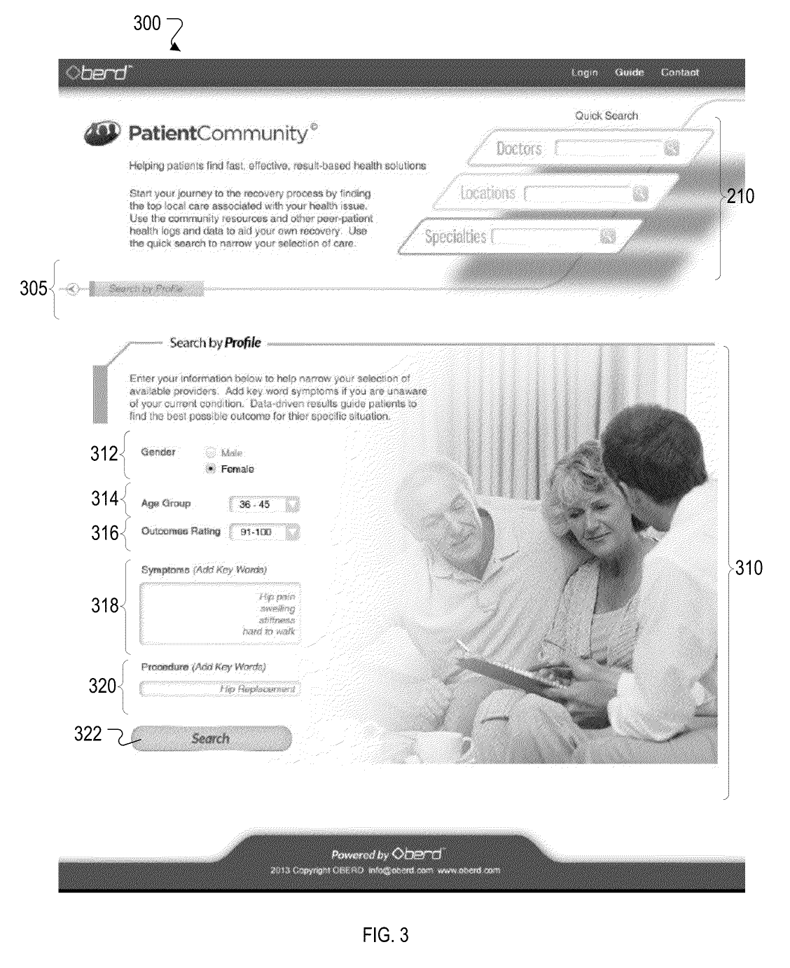

FIGS. 3-8 are now described. In general, FIGS. 3-8 show screen images of graphical user interfaces for an application in communication with the health care entity system 100 (FIG. 1). In a particular example, the graphical user interfaces shown in FIGS. 3-8 illustrate aspects of an online patient community system that pertain to the features of the health care entity system 100 that relate to patient-to-doctor searching and communication.

Referring now to FIG. 3, a screen image of a graphical user interface 300 is shown that may be presented to a user allowing the user to perform one or more searches for service providers. The graphical interface 300 includes the quick search region 210, a search activity indicator 305, and a second search region 310.

The search activity indicator 305 can provide one or more user interface elements with respect to a particular user's search activity. The search activity indicator 305 is shown in multiple of the graphical interfaces 300, 400, and 500. In some implementations, when a user selects one of the user interface elements, a respective graphical user interface changes so that a selected activity is presented in a different graphical user interface. Additional examples of the search activity indicator are described in more detail elsewhere in this specification.

The second search region 310 allows the user to perform a more refined search that the quick search region 210 by allowing the user to provide additional information for a particular kind of search to find information for which the user is searching. In the depicted example, the second search region 310 allows a user to search for service providers based on profile information that is stored by the health care entity system 100 (FIG. 1). Examples of providing profile information are described in more detail elsewhere in this specification. In some implementations, the search region 310 may allow for other kinds of searching, such as searching by doctor, searching by location, searching by specialty, and so forth. In general, second search region 310 is populated with various user input controls based on the type of search to be performed.

In an example, because the second search region 310 is being used to search by profile, one or more user input controls 312-320 can be presented to relate to profile information that pertains to one or more users of the health care entity system 100 (FIG. 1). In general, a user can provide input into one or more of the user input controls 312-320 to search the profiles of the users of the health care entity system 100 according to the search criteria provided by the user.

In a particular example, the user input control 314 can be used to search users of the health care entity system 100 based on the respective ages of the users of the health care entity system 100. In other particular examples, a user can provide an outcome rating range into the user input control 316, symptoms into the user input control 318, and procedures into the user input control 320. These and other aspects of profile information stored in the health care entity system 100 are described elsewhere in this specification. In this example, the outcome rating that is provided by a user is used to search outcome ratings that have been provided by authenticated users only. Other ratings can also be provided as described elsewhere in this specification. Determining when a user is an authenticated user is described in more detail below.

In an example, controls in second search region 310 can be automatically populated with values that are included in a user profile. In this example, server 112, accesses information indicative of a patient profile of the user. Server 112 determines, based on contents of the user profile, one or more symptoms of the user. In this example, server 112 pre-populates user input control 318 with the determined one or more symptoms of the user. In this example, a user profile is being used to drive identification of a medical service provider who is qualified to address at least one of the one or more symptoms of the user. In this example, user input control 318 includes a visual representation of the determined one or more symptoms.

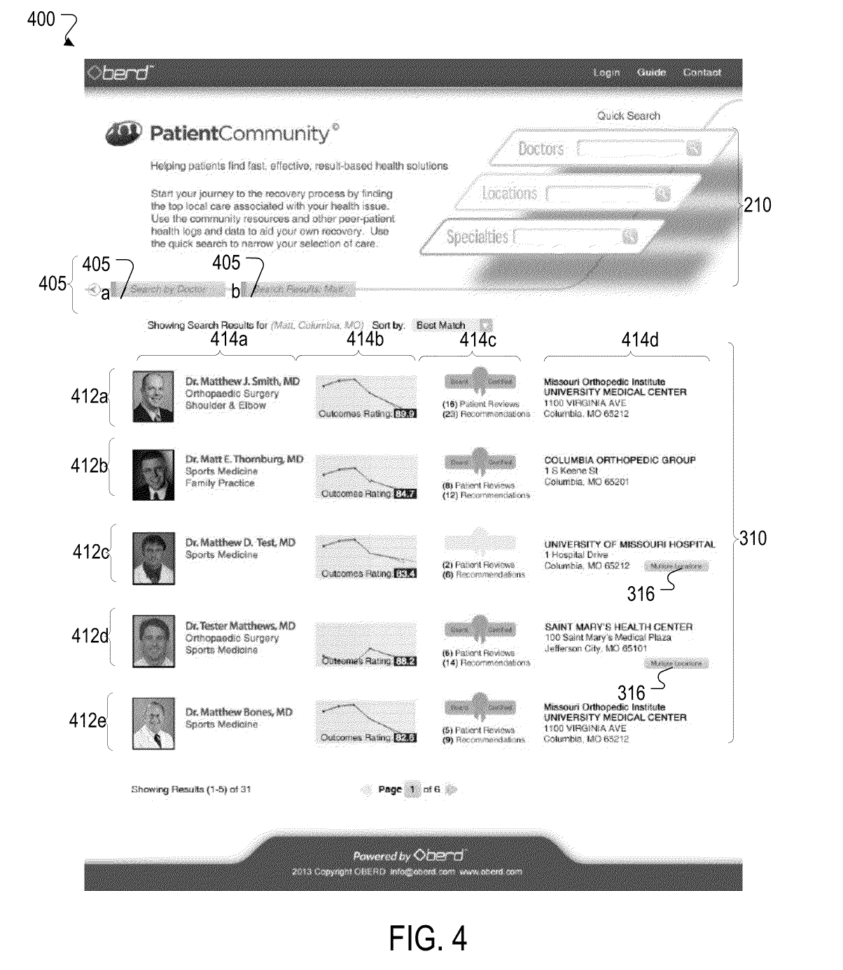

Referring now to FIG. 4, a screen image of a graphical user interface 400 is shown that can be used to provide search results. In a particular example, the graphical user interface 400 provides search results according to a search conducted by a user to identify one or more doctors. A similar interface may also be provided when the search is for other users in the health care entity system 100 (FIG. 1) or other searches such as location searches, specialty searches, and so forth.

In general, the graphical user interface 400 includes the quick search region 210, the search activity indicator 305, and a detailed search results region 410. In the depicted example, the search activity indicator 305 includes user interface elements 305a and 305b. The user interface element 305b represents the current search activity of providing search results. If, for example, a user were to select user interface element 305a, the graphical user interface 400 would change so that a user could provide search criteria, similar to the manner in which a user can provide search criteria using graphical user interface 300.

In general, the detailed search results region 410 can be organized in a table-like fashion to provide information about one or more doctors, where the information is responsive to a search request or other request for information. In a particular example, the detailed search results region 410 includes one or more rows 412a-412e and one or more columns, 414a-414d.

Each of the rows 412a-412e provides information about each of the particular doctors whose information matched or was otherwise responsive to a particular search request or other request for information. Column 414a presents personal information about a particular doctor in each of the respective rows 412a-412e. In an example, the column 414a can present a picture of the doctor, their name, and any of their specialties. In a particular example, column 414a for row 412a indicates that the doctor's name is “Dr. Matthew J. Smith, MD” with specialties in orthopedic surgery and shoulder and elbow surgery.

Column 414b shows a graphical representation of the doctor's outcome rating. In an example, this can be shown as an overall rating, as a trend, and combinations of these. In addition, in an example, the outcome rating may be shown for pre-op care, surgical care, and follow-up care. In a particular example, column 414b for row 412 indicates that the doctor's overall outcome rating is 89.9. Outcome ratings are described in more detail elsewhere in this specification.

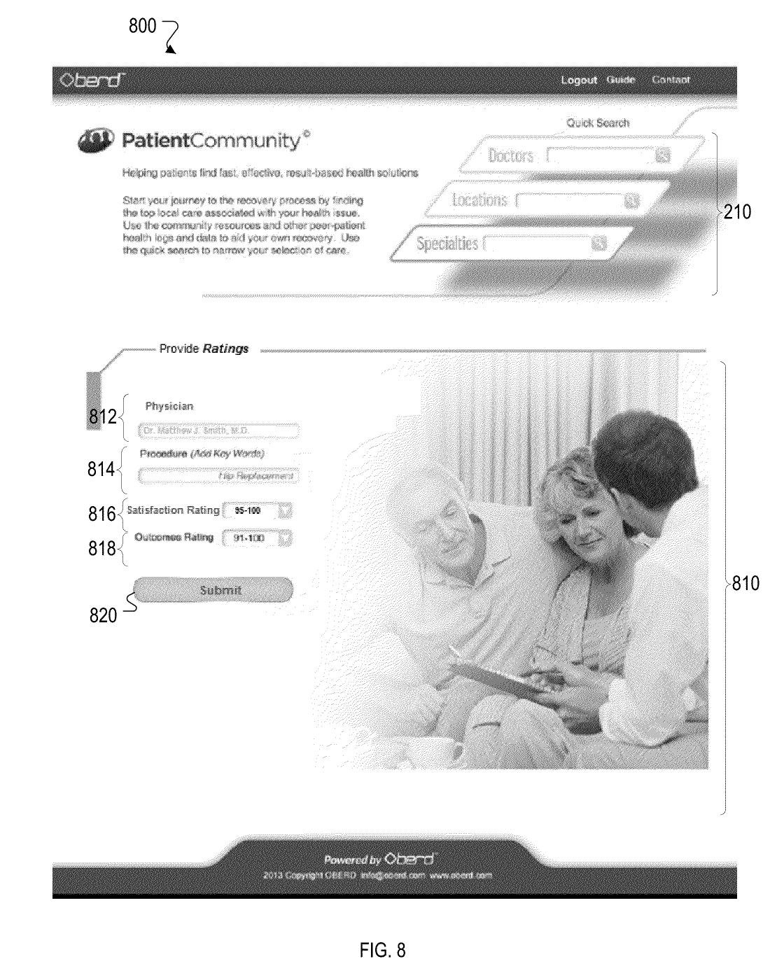

In general, the outcome ratings shown in column 414b are provided by authenticated users only. In an example, a graphical user interface shown in FIG. 8 can be presented to authenticated users that allow a particular authenticated user to provide an outcome rating to the health care entity system 100 (FIG. 1). As a result, all users of the health care entity system 100 (both authenticated and unauthenticated users) may have a higher degree of confidence about the presented outcome ratings than if unauthenticated users are allowed to provide outcome ratings.

Column 414c provides additional user-selectable elements that can be viewed to provide additional information about a particular doctor. In an example, the column 414c can provide links to patient reviews and recommendations. That is, if a user selects a link corresponding to either the patient reviews or the recommendations, the graphical user interface 400 may change to present the selected reviews or recommendations. In addition, the user-selectable elements may include a number that indicates a number of patient reviews or recommendations. In a particular example, column 414c indicates for row 412a that there are 18 patient reviews and 23 recommendations.

In general, the health care entity system 100 (FIG. 1) can limit the authoring of reviews and recommendations to authenticated users only. In an example, a graphical user interface can be presented to authenticated users that allow a particular authenticated user to provide a review or recommendation to the health care entity system 100. As a result, users of the health care entity system 100 may have a higher degree of confidence about the presented reviews and recommendations than if unauthenticated users are allowed to provide reviews or recommendations.

Column 414d provides location information about particular doctors. In some implementations, the location information is the particular hospital or clinic where the doctor practices. In other implementations, the location information is a particular group in which the doctor belongs. In these and other implementation, there may be multiple locations in which the doctor practices. In a particular example, where a particular doctor is affiliated with multiple locations, a user interface control 416 can be presented that when selected presents the other locations to the user.

In some implementations, one or more portions of the rows 412a-412e and the columns 414a-414d are user selectable. In response, the graphical user interface 400 may change to present additional information that corresponds to the selection. In a particular example, if a user selects a representation in column 414a, the user interface 400 may change to provide more detailed information about the selected doctor.

Referring now to FIG. 5, a screen image of a graphical user interface 500 is shown that can be used to present additional information about a selected doctor. In some implementations, the graphical user interface 500 can be shown when a user selects elements of the detailed search region 410 (FIG. 4), such as particular columns 414a-414d in any of the rows 412a-412e. In general, the graphical user interface includes the quick search region 210, the search activity indicator 305, and a doctor information region 510.

In the depicted example, the search activity indicator 305 includes user interface elements 305a, 305b, and 305c. The user interface element 305c represents the current search activity of providing additional information about the selected doctor. If, for example, a user were to select the user interface element 305a, the graphical user interface 500 would change so that a user could provide search criteria, similar to the manner in which a user can provide search criteria using graphical user interface 300.

Similarly, if the user where to select the use interface element 305b, the graphical user interface 500 would change so that a user could review particular search results, similar to the manner in which the user can review search results using graphical user interface 400.

The doctor information region 510 includes information about the selected doctor. In a particular example, the doctor information region 510 can include a picture of the doctor, a description of the doctor's particular specialties, a satisfaction rating indicator 512, an outcome rating indicator 514, a map region 516, and one or more additional components 518-524 that can be selected to provide additional information about the doctor. In general, the satisfaction rating indicator 512 and the outcome rating indicator 514 present information provided by authenticated users of the health care entity system 100 (FIG. 1) only. That is, in an example the health care entity system 100 prevents unauthenticated users from providing information that the health care entity system 100 can use to generate information indicative of a satisfaction rating or an outcome rating.

The satisfaction ratings indicator 512 can show how particular patients, such as authorized users of the health care entity system 100 (FIG. 1), have rated the particular doctor. In a particular example, the satisfaction rating indicator 512 is a graph or chart this includes positive ratings, negative ratings, and neutral ratings. In addition, these positive ratings, negative ratings, and neutral ratings can be used by the health care entity system 100 to compute an over satisfaction rating for the particular doctor. Various techniques can be used by the health care entity system 100 to determine the overall rating of the doctor, including computing an average rating based on one or more rating scores provided by users of the health care entity system 100.

The outcome ratings indicator 514 may be similar to the information presented in column 414b of the detailed search results region 410 (FIG. 4). In some implementations, the outcome ratings indicator 514, however, may be enlarged or include additional information not able to be presented in the detailed search results region 410. In the depicted example, the outcome ratings indicator 514 presents an average outcome rating. In general, an outcome rating is based on some amount of information provided by a physician about an expected outcome and determining whether the actual outcome was in-line with the expectations. In an example, the outcome rating is based on a collection of patient outcome-based data. Generally, patient outcome-based data includes data collected by the health care entity system 100 (FIG. 1) to evaluate the capacity of a medical procedure and/or process to function at a pre-defined level. In a particular example, if a procedure has an average recovery of 8 weeks, the outcome rating can be based on a number of patients that are treated by the particular doctor that recover more quickly than average, recovery less quickly than average, and recover on average with the pre-defined recover level.

In some implementations, the outcome ratings can be subdivided into pre-op expectation ratings 514a, surgical expectation ratings 514b, and follow-up expectation ratings 514c. In an example, the outcome rating can be based different ratings for each of pre-op expectation ratings 514a, surgical expectation ratings 514b, and the follow-up expectation ratings 514c.

The map region 516 can present a location of doctor in a surrounding area. In some implementations, the map region 516 can be zoomed-in or zoomed-out to provide addition views of the location and surrounding area. The one or more additional components 518-528 that can be selected by user based on the wanting to view other information about the doctor. As an example, the user can select the additional component 518 to view more information about the doctor's education and background based on information that is stored on the health care entity system 100 (FIG. 1). As another example, components 526 and 528 can be selected by a user to view patient reviews and recommendations, respectively, provided by authorized users of the health care entity system 100. That is, component 526 is indicative of patient reviews (by authenticated users) for medical service provider 307. In this example, component 526 is a link, selection of which causes a display of individual reviews for service provider 307.

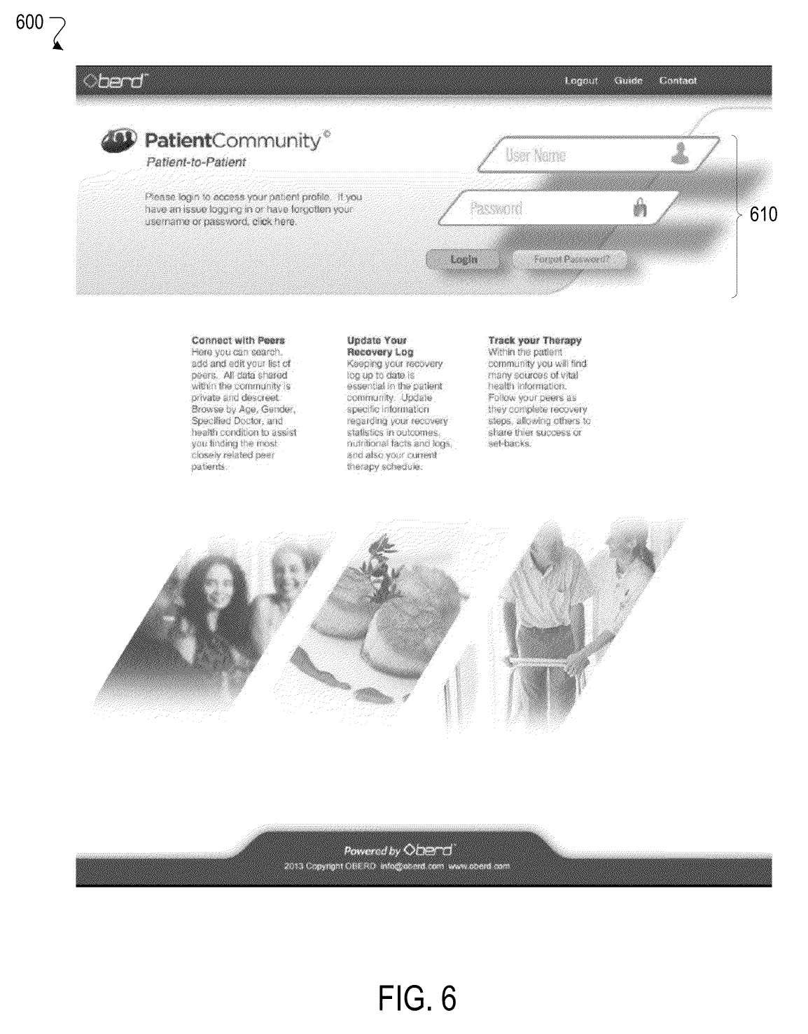

Referring now to FIG. 6, a screen image of a graphical user interface 600 is shown that can be used as a login page, landing page, or other home page for users of the health care entity system 100 (FIG. 1). In general, the graphical user interface 600 includes a user credential region 610 that allows a user to provide at least a username and password. The health care entity system 100 can verify the provided username and password to grant access to the health care entity system 100.

In some implementations, providing the user credentials in region 610 may serve to authenticate the user. In an example, when a user provides a username and associated password in the user credential region 610. In this example, an authentication rules engine can compare the provided user name and password against one or more entries in a user credential database or other data store. In this example, when a username matches a password provided by the user, the health care entity system 100 (FIG. 1) may consider the particular user an authenticated user.

In some implementations, additional steps may be performed by the health care entity system 100 (FIG. 1) to authenticate a particular user. In an example, information provided by the particular user in their respective profile can be compared with one or more pieces of information stored by the health care entity system 100. In a particular example, one or more aspects of a particular user's profile pertaining to their medical condition and treatments can be compared with medical records that are stored by the health care entity system 100 to authenticate a particular user. In some implementations medical professionals visited, procedures undergone, and so forth in the particular user's medical records can be compared with information in the particular user's profile to verify that the particular user is who they claim to be. Other authentication techniques are also possible, including performing a callback or other follow-up communication with a particular user based on information provided in their profile, validation and/or visual inspection of the information provided by the particular user by operators of the health care entity system 100, and so forth.

In some implementations, the additional authentication techniques—such as checking one or more aspects of a particular user's profile against medical records stored by the health care entity system 100—are performed by the health care entity system 100 initially to authenticate the particular user. Then, the health care entity system 100 can authenticate the user on subsequent visits to the health care entity system 100 when the particular user provides a username and password in the user credential region 610, as described above.

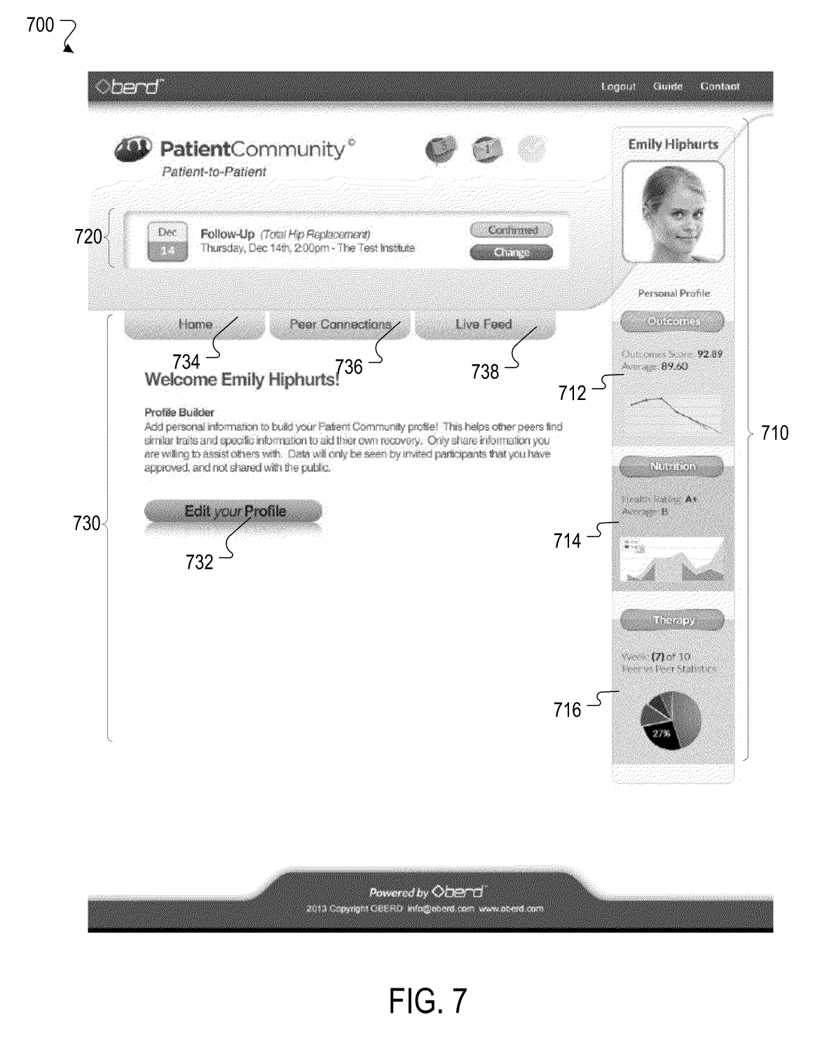

Referring now to FIG. 7, a screen image of a graphical user interface 700 is shown that can be used as a welcome page and/or profile page for a particular user of the health care entity system 100 (FIG. 1). In general, the graphical user interface 700 is provided to authenticated users only. In an example, the graphical user interface 700 can be presented to a user once the health care entity system 100 has verified the username and password provided the user in the user credential region 610 (FIG. 6). In general, the graphical user interface 700 provides one or more graphical user components that allow a user to manage their patient profile on the health care entity system 100, track their recovery progress relative to other users of the health care entity system 100, search for other user of the health care entity system 100 based on similar procedures performed or other search criteria, and provide ratings pertaining to medical professionals, to name few examples. In a particular example, the graphical user interface 700 includes a profile region 710, an appointment region 720, and an information region 730.

The profile region 710 includes graphical representations indicative of certain information about a particular user's recovery or general health. In a particular example, the profile region 710 includes a picture of the user, an outcome score region 712, a nutrition region 714, and a therapy region 714. In general, the graphical representatives in the profile region 710 are indicative of different aspects of the user's recovery that are determined from information that the particular user enters into a recovery log or other aspect of the particular user's profile.

In general, the outcome score region 712 includes an outcome score for one or more procedures that the particular user has undergone. In some implementations, the outcome score region 710 may be subdivided into a pre-operative outcome score region, an operative outcome score region, and a follow-up outcome score region, similar to the subdivisions described in reference to FIG. 5. In an example, the outcome score presented in the outcome score region 712 for the particular user can be based on their respective progress relative to all other users of the health care entity system 100 that have undergone a similar procedure. In another example, the outcome score presented in the outcome score region 712 for the particular user can be based on their respective progress relative to only those users of the health care entity system 100 to which the users are acquainted or otherwise connected, e.g., through a friending processes or other similar process that is supported by social networks in general. A particular example of connecting with other users of the health care entity system 100 is described in more detail elsewhere in this specification.

In general, the nutrition and health region 714 includes an indication of the particular user's health rating. In some implementations, the health rating can be based on nutrition information that is entered by the user and compared with a nutritional database and/or compared to one or more users of the health care entity system 100 (FIG. 1). In an example, the health rating presented in the nutrition and health region 714 for the particular user can be based on their respective health and nutrition information relative to all other users of the health care entity system 100 that have undergone a similar procedure. In another example, the health rating presented in the nutrition and health region 714 for the particular user can be based on their respective health and nutrition information relative to only those users of the health care entity system 100 to which the users are acquainted or otherwise connected, e.g., through a friending processes or other similar process that is supported by social networks in general.

In general, the therapy region 716 includes an indication of the particular user's progress in a therapy regimen. In general, the indication can be based on the particular user's current timetable with respect to their medical procedure. In an example, the therapy regimen may be a pre-operative regimen. In another example, the therapy regimen may be a post-operative regimen. In some implementations, the indication in the therapy region 716 can be based on a calendar other appointment schedule that a user of the health care entity system 100 (FIG. 1) can provide physical therapy appointments. In a particular example, the therapy region 716 indicates that the particular user of the health care entity system 100 is on their seventh week of a ten-week therapy regimen. In some implementations, the therapy region 716 also provides a user interface component that allows a particular user to track or otherwise compare their respective therapy progress relative to other users of the health care entity system 100. In an example, therapy comparison for the particular user can be based on their respective progress relative to all other users of the health care entity system 100 that have undergone a similar procedure and/or therapy regimen. In another example, the comparison for the particular user can be based on their respective progress relative to only those users of the health care entity system 100 to which the users are acquainted or otherwise connected, e.g., through a friending processes or other similar process that is supported by social networks in general.

In general, the appointment region 720, can allow a particular user to track important or other relevant appointments relative to a user's medical care. In general, the appointment region 720 may be populated with information that is collect from the user or on behalf of the user. In an example, the appointment region 720 may be populated by referencing medical information stored on a computer at a hospital or other location in which the health care entity system 100 can communicate. In another example, the appointment region 720 may be populated with information that is entered by the particular user, e.g., in a recovery log or other aspects of the particular user's profile. In some implementations, the appointment region 720 allows a user to confirm or change a particular scheduled appointment using various user interface components.

In general, the information region 730 presents information to the particular user that is indicative of various aspects of their user profile. In addition, the information region 730 may provide one or more user interface components that allow a particular user to enter information that pertains to the particular user's recovery.

In an example, the information region 730 includes a profile edit button 732 and one or more selectable user interface tabs 734, 736, and 738. In general, the profile edit button 732 allows the particular user to make changes to their respective profile information. In general, the one or more selectable user interface tabs 734, 736, and 738 that allow a user to present different information in the information region 730 and perform various activities that edit or otherwise affect the contents of the user's profile. Editing profile information and performing a number of other activities are described elsewhere in this specification.

In some implementations, the information region 730 may include other selectable user interface components that allow an authenticated user to provide one or more different ratings about a particular medical professional. In some implementations, when a user selects one of these other user selectable user interface components, the health care entity system 100 (FIG. 1) may determine whether the user is an authenticated user. If the user is determined to be an authenticated user, the health care entity system 100 (FIG. 1) may cause the application that is presenting graphical user interface 700 to present a graphical user interface 800 that allows a user to submit or otherwise provide information that pertains to a health grade rating for a particular medical service provider.

Referring now to FIG. 8, a screen image of a graphical user interface 800 is shown that can be used by an authenticated user to submit one or more health grade ratings for a particular medical service provider. In some implementations, the health grade ratings can be one of a patient review, a patient recommendation, a satisfaction rating and an outcome rating. In a particular example, the graphical user interface 800 includes the quick search region 210 and a ratings region 810, although other regions are also possible.

The ratings region 810 can present one or more user input controls 812-820 that enable an authorized user to provide on or more health care ratings for a particular physician. In the depicted example of FIG. 8, the ratings region 810 includes a physician user input control 812, a procedure user input control 814, a satisfaction rating user input control 816, an outcome rating user input control 818, and a submission button 820, although other user input controls such as a recommendation user input control and a review user input control are also possible.

Once a user is satisfied with the health care rating information entered into one or more of the user input controls 812-818, the user may select the submission button 820 to submit their rating of the particular medical service provider to the health care entity system 100 (FIG. 1). In response, the health care entity system 100 may add the health care rating information received from the user to the other health care rating information for the particular medical service provider. In an example, a database or other data store may store one or more records of health care rating information that pertains to a particular medical service provider. In this example, upon receipt of a new health care rating for the particular medical service provider, the health care entity system 100 can generate and store one or more values in the database or data store that reflect the received health rating information from the authenticated user.

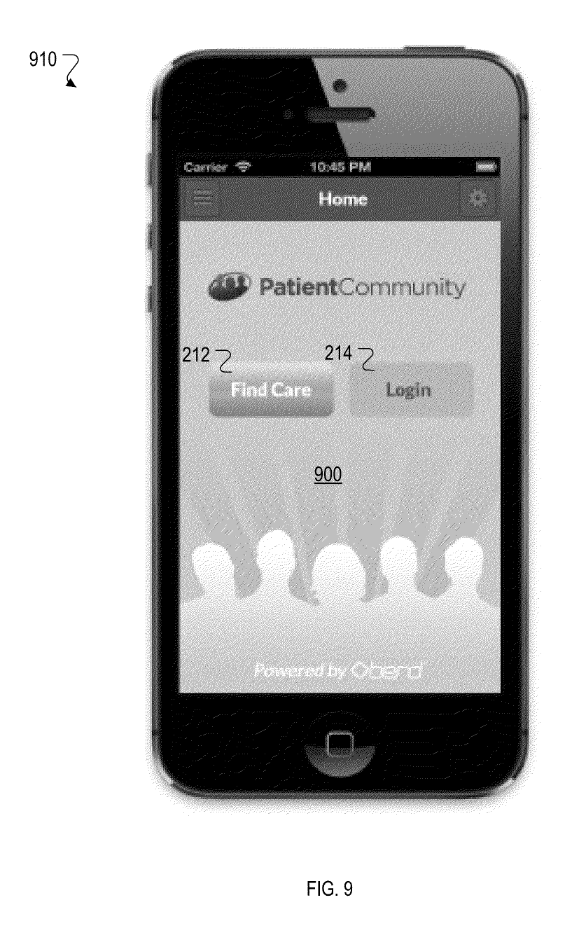

Referring now to FIG. 9, a screen image of a graphical user interface 900 is being shown as part of an application loaded on a client device 102 or 108, such as a handheld device 910. In the depicted example, the graphical user interface 900 is similar to the graphical user interface 200 (FIG. 2) that provides a landing screen or home screen to a particular application that can be used to communicate with the health care entity system 100 (FIG. 1). The graphical user interface 900, however, may be customized to fit a smaller screen of the handheld device 910 relative to other client device 102 or 108, such as a desktop computer, laptop computer, and so forth.

In addition, if a user selects either of the “find care” user interface control 212 or the “login” user interface control 214, the application can present additional graphical user interfaces described elsewhere in this specification that satisfy the user selection. In an example, if a user selects the “login” user interface control 214, the user may be presented with a graphical user interface that is similar to the graphical user interface 600 (FIG. 6), e.g., for the purposes of the authenticating the particular user. In some implementations, however, the user interface may also be customized to fit a small screen of the handheld device 910.

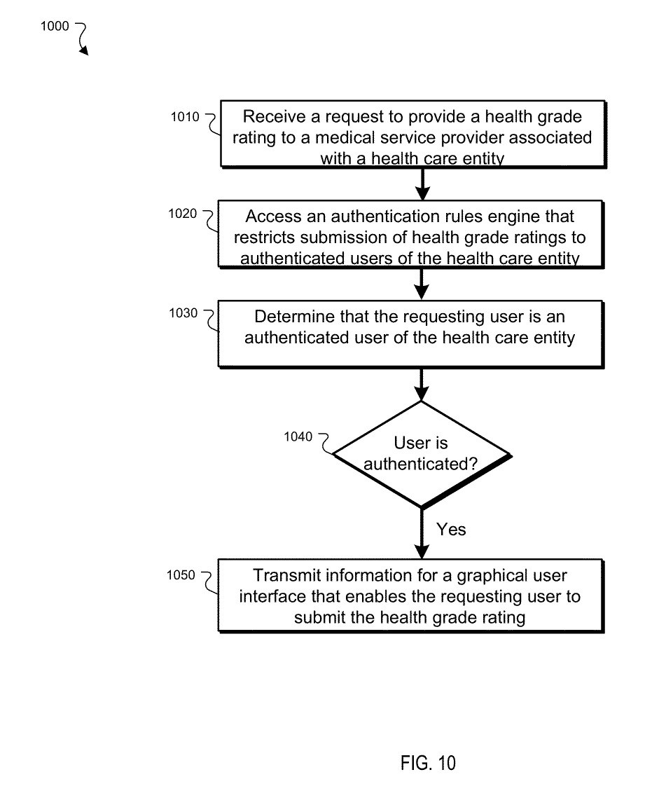

FIG. 10 is a flow chart of an example process 1000 that can be used to ensure that health grade ratings are provided by authenticated users only. In general, a rules authentication engine can be used to determine whether a particular user is authenticated on unauthenticated and permit or restrict the particular user from providing health grade ratings, accordingly. In general, the process 900 is described in relation to a server 112 (FIG. 1) that is configured to perform the process 900, although other systems may be configured to perform the process 900.

In operation, the server 112 receives (1010), by a processing device and from a client device associated with a requesting user, a request to provide a health grade rating for a medical service provider who is associated with a health care entity.

In some implementations, the health grade rating may be a combination of one or more of a patient review, a patient recommendation, a satisfaction rating and an outcome rating. In such implementations, the outcome rating is indicative of a strength of an assessment of one or more of a pre-operative condition, an operative procedure, and a post-operative condition, e.g., as described elsewhere in this specification.

The server 112 accesses (1020), in response to the request, an authentication rules engine that restricts submission of health grade ratings to authenticated users of the health care entity. In an example, the authentication rules engine compares provided user credentials with information stored by the server 112 to restrict submission of health grade ratings. In another example, authentication rules engine can perform a validation process, such as comparing information in a particular user's profile of with medical records accessible by the system to restrict the submission of health grade ratings to authenticated users.

The server 112 determines (1030), based on execution of the authentication rules engine, that the requesting user is an authenticated user of the health care entity. In an example, when the server matches a received username and password with a stored username and password of an authenticated user, the server 112 determines that the requesting user is an authenticated user. In another example, server 112 determines that the requesting user is an authenticated user based on identifying a social connection between the requesting user and the health care entity, e.g., in a social networking platform. In this example, server 112 sends a request, e.g., to the social networking platform, for information indicative of a social connection between the health care entity and the requesting user (and/or between the requesting user and a service provider associated with the health care entity). In response, the social networking platform determines whether a social connection exists between the requesting user and the health care entity (e.g., if the health care entity itself has an account and/or is a user of the social networking platform). If the social networking platform identifies that such a connection exists, then the social networking platform transmits—to the server 112—information specifying the existence of the social connection. Upon receipt of this information, server 112 authenticates the requesting user as an authenticated user.

In another example, the social networking platform determines whether a social connection exists between the requesting user and a service provider associated with the health care entity (e.g., a physician who works for the health care entity). If the social networking platform identifies that such a connection exists, then the social networking platform transmits—to the server 112—information specifying the existence of the social connection. Upon receipt of this information, server 112 authenticates the requesting user as an authenticated user. In still another example, the social networking platform determines whether a social connection exists between the requesting user and another user who is connected to a service provider associated with the health care entity (e.g., a physician who works for the health care entity). If the social networking platform identifies that such a connection exists, then the social networking platform transmits—to the server 112—information specifying the existence of the social connection. Upon receipt of this information, server 112 authenticates the requesting user as an authenticated user.

In some implementations, the health care entity is an online patient community for generating social connections between users of the online patient community. In such implementations, determining that the requesting user is an authenticated user of the online patient community promotes an increase in a quality of health grade ratings, relative to a quality of health grade ratings that would be provided by unauthenticated users.

If the server determines that the requesting user is authenticated (1040), the server 112 transmits (1050), to the client device, information for a graphical user interface that enables the requesting user to submit the health grade rating for the medical service provider. In an example, the server 112 (FIG. 1) can cause an application executing on a client device 102 or 108 (FIG. 1) to present graphical user interface 800 (FIG. 8), upon the determining that the requesting user is an authenticated user. In this example, server 112 prevents graphical user interface 800 from being displayed to a user, e.g., until the user is authenticated as an authorized user. In some implementations, the medical service provider is a first medical service provider. In such implementations, the server 112 can access information indicative of health grade ratings for a second medical service provider who is associated with the health care entity, with the health grade ratings for the second medical service provider being provided by first authenticated users who are associated with the health care entity. In an example, the server 112 can access information indicative of health grade ratings for the second medical service provider based on a similarity between the first medical service provider and the second medical service provider. In a particular example, the second medical service provider may be provided because they perform similar procedures, have a similar outcome rating, have a similar satisfaction rating, or have other similarities.

The server 112 may also access information indicative of health grade ratings for a third medical service provider who is associated with the health care entity, with the health grade ratings for the third medical service provider being provided by second authenticated users who are associated with the health care entity. In an example, the server 112 can access information indicative of health grade ratings for the third medical service provider based on a similarity between the either of the first medical service provider or the second medical service provider with the third medical service provider. In a particular example, the third medical service provider may be provided because they perform similar procedures, have a similar outcome rating, have a similar satisfaction rating, or have other similarities.

The server 112 may also generate, based on a comparison of the health grade ratings for the second medical service and the health grade ratings for the third medical service, an evaluation of the second medical service provider relative to the third medical service provider, with the evaluation specifying strengths of the second medical service provider relative to strengths of the third medical service provider, with the specified strengths being based on the health grade ratings for the second medical service and the health grade ratings for the third medical service. In an example, the server 112 may provide a side-by-side comparison of at least some information included in the outcome rating for the first medical service provider, the second medical service provider, and the third medical service provider, including pre-operative outcome scores, procedure outcome scores, and follow-up outcome scores.

In some implementations, the health care entity may be an online patient community. In such implementations, the online patient community may include medical service providers and users. As a result, the server 112 can restrict access for submission of health grade ratings for medical service providers who are members of the online patient community to users who are members of the online patient community.

In some implementations, the client device includes a first client device, and the server 112 can receive, from a second client device of a searching user, a request to search for a medical service provider associated with one or more predefined attributes that are specified by the searching user as defining an acceptable medical service provider. In such implementations, the server 112 can also identify, in response to the request to search, a medical service provider that is associated with at least one of the one or more predefined attributes. The sever 112 can also identify, for the identified medical service provider, one or more health grade ratings, with the identified one or more health grade ratings being provided by authenticated users of the health care entity. The server 112 can also transmit, to the second client device, information identifying the identified medical service provider and the identified one or more health grade ratings.

In some implementations, the health care entity may be a hospital. In such implementations, when the server 112 determines, based on execution of the authentication rules engine, that the requesting user is an authenticated user of the hospital, the server 112 may access a data repository that is associated with the hospital. The server 112 may also identify, in data base records that are accessed through the data repository, information specifying that the requesting user is a patient of the hospital. In an example, the server 112 can compare medical record information with profile information maintained by the server to determine that requesting user is a patient of the hospital.

Embodiments can be implemented in digital electronic circuitry, or in computer hardware, firmware, software, or in combinations thereof. An apparatus can be implemented in a computer program product tangibly embodied or stored in a machine-readable storage device for execution by a programmable processor; and method actions can be performed by a programmable processor executing a program of instructions to perform functions by operating on input data and generating output. The embodiments described herein, and other embodiments of the invention, can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method or parts thereof may use the “World Wide Web” (Web or WWW), which is that collection of servers on the Internet that utilize the Hypertext Transfer Protocol (HTTP). HTTP is a known application protocol that provides users access to resources, which may be information in different formats such as text, graphics, images, sound, video, Hypertext Markup Language (HTML), as well as programs. Upon specification of a link by the user, the client computer makes a TCP/IP request to a Web server and receives information, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Sun, Linux, and Macintosh may also be used. Computer users can view information available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of exemplary embodiments of the invention have been described. Nevertheless, it will be understood by one of ordinary skill in the art that various modifications may be made without departing from the spirit and scope of the invention.

What is claimed is:

1. A computer-implemented method, comprising:
receiving, by a processing device and from a client device associated with a requesting user, a request to provide a health grade rating for a medical service provider who is associated with a health care entity;
accessing, in response to the request, an authentication rules engine that restricts submission of health grade ratings to authenticated users of the health care entity;
determining, based on execution of the authentication rules engine, that the requesting user is an authenticated user of the health care entity; and
in response to determining that the requesting user is authenticated,
transmitting, to the client device, information for a graphical user interface that enables the requesting user to submit the health grade rating for the medical service provider.

2. The computer-implemented method of claim 1, wherein the health care entity comprises an online patient community for generating social connections between users of the online patient community; and
wherein determining that the requesting user is an authenticated user of the online patient community promotes an increase in a quality of health grade ratings, relative to a quality of health grade ratings that would be provided by unauthenticated users.

3. The computer-implemented method of claim 1, wherein the medical service provider is a first medical service provider, and wherein the method further comprises:
accessing information indicative of health grade ratings for a second medical service provider who is associated with the health care entity, with the health grade ratings for the second medical service provider being provided by first authenticated users who are associated with the health care entity;
accessing information indicative of health grade ratings for a third medical service provider who is associated with the health care entity, with the health grade ratings for the third medical service provider being provided by second authenticated users who are associated with the health care entity; and
generating, based on a comparison of the health grade ratings for the second medical service and the health grade ratings for the third medical service, an evaluation of the second medical service provider relative to the third medical service provider, with the evaluation specifying strengths of the second medical service provider relative to strengths of the third medical service provider, with the specified strengths being based on the health grade ratings for the second medical service and the health grade ratings for the third medical service.

4. The computer-implemented method of claim 1, wherein the health grade rating comprises one or more of a patient review, a patient recommendation, a satisfaction rating and an outcome rating;
wherein the outcome rating is indicative of a strength of an assessment of one or more of a pre-operative condition, an operative procedure, and a post-operative condition.

5. The computer-implemented method of claim 1, wherein the health care entity comprises an online patient community, wherein the online patient community comprises medical service providers and users, and wherein the method further comprises:
restricting access for submission of health grade ratings for medical service providers who are members of the online patient community to users who are members of the online patient community.

6. The computer-implemented method of claim 1, wherein the client device comprises a first client device, and wherein the method further comprises:
receiving, from a second client device of a searching user, a request to search for a medical service provider associated with one or more predefined attributes that are specified by the searching user as defining an acceptable medical service provider;
identifying, in response to the request to search, a medical service provider that is associated with at least one of the one or more predefined attributes;
identifying, for the identified medical service provider, one or more health grade ratings, with the identified one or more health grade ratings being provided by authenticated users of the health care entity; and
transmitting, to the second client device, information identifying the identified medical service provider and the identified one or more health grade ratings.

7. The computer-implemented method of claim 1, wherein the health care entity comprises a hospital, and wherein determining, based on execution of the authentication rules engine, that the requesting user is an authenticated user of the hospital comprises:
accessing a data repository that is associated with the hospital; and
identifying, in data base records that are accessed through the data repository, information specifying that the requesting user is a patient of the hospital.

8. One or more machine-readable hardware storage devices storing instructions that are executable by one or more processing devices to perform operations comprising:
receiving, from a client device associated with a requesting user, a request to provide a health grade rating for a medical service provider who is associated with a health care entity;
accessing, in response to the request, an authentication rules engine that restricts submission of health grade ratings to authenticated users of the health care entity;
determining, based on execution of the authentication rules engine, that the requesting user is an authenticated user of the health care entity; and
in response to determining that the requesting user is authenticated,
transmitting, to the client device, information for a graphical user interface that enables the requesting user to submit the health grade rating for the medical service provider.

9. The one or more machine-readable hardware storage devices of claim 8, wherein the health care entity comprises an online patient community for generating social connections between users of the online patient community; and
wherein determining that the requesting user is an authenticated user of the online patient community promotes an increase in a quality of health grade ratings, relative to a quality of health grade ratings that would be provided by unauthenticated users.

10. The one or more machine-readable hardware storage devices of claim 8, wherein the medical service provider is a first medical service provider, and wherein the operations further comprise:
accessing information indicative of health grade ratings for a second medical service provider who is associated with the health care entity, with the health grade ratings for the second medical service provider being provided by first authenticated users who are associated with the health care entity;
accessing information indicative of health grade ratings for a third medical service provider who is associated with the health care entity, with the health grade ratings for the third medical service provider being provided by second authenticated users who are associated with the health care entity; and
generating, based on a comparison of the health grade ratings for the second medical service and the health grade ratings for the third medical service, an evaluation of the second medical service provider relative to the third medical service provider, with the evaluation specifying strengths of the second medical service provider relative to strengths of the third medical service provider, with the specified strengths being based on the health grade ratings for the second medical service and the health grade ratings for the third medical service.

11. The one or more machine-readable hardware storage devices of claim 8, wherein the health grade rating comprises one or more of a patient review, a patient recommendation, a satisfaction rating and an outcome rating;
wherein the outcome rating is indicative of a strength of an assessment of one or more of a pre-operative condition, an operative procedure, and a post-operative condition.

12. The one or more machine-readable hardware storage devices of claim 8, wherein the health care entity comprises an online patient community, wherein the online patient community comprises medical service providers and users, and wherein the operations further comprise:
restricting access for submission of health grade ratings for medical service providers who are members of the online patient community to users who are members of the online patient community.

13. The one or more machine-readable hardware storage devices of claim 8, wherein the client device comprises a first client device, and wherein the operations further comprises:
receiving, from a second client device of a searching user, a request to search for a medical service provider associated with one or more predefined attributes that are specified by the searching user as defining an acceptable medical service provider;
identifying, in response to the request to search, a medical service provider that is associated with at least one of the one or more predefined attributes;
identifying, for the identified medical service provider, one or more health grade ratings, with the identified one or more health grade ratings being provided by authenticated users of the health care entity; and
transmitting, to the second client device, information identifying the identified medical service provider and the identified one or more health grade ratings.

14. The one or more machine-readable hardware storage devices of claim 8, wherein the health care entity comprises a hospital, and wherein determining, based on execution of the authentication rules engine, that the requesting user is an authenticated user of the hospital comprises:
accessing a data repository that is associated with the hospital; and
identifying, in data base records that are accessed through the data repository, information specifying that the requesting user is a patient of the hospital.

15. An electronic system comprising:
one or more processing devices; and
one or more machine-readable hardware storage devices storing instructions that are executable by the one or more processing devices to perform operations comprising:
receiving, from a client device associated with a requesting user, a request to provide a health grade rating for a medical service provider who is associated with a health care entity;
accessing, in response to the request, an authentication rules engine that restricts submission of health grade ratings to authenticated users of the health care entity;
determining, based on execution of the authentication rules engine, that the requesting user is an authenticated user of the health care entity; and
in response to determining that the requesting user is authenticated,
transmitting, to the client device, information for a graphical user interface that enables the requesting user to submit the health grade rating for the medical service provider.

16. The electronic system of claim 15, wherein the health care entity comprises an online patient community for generating social connections between users of the online patient community; and
wherein determining that the requesting user is an authenticated user of the online patient community promotes an increase in a quality of health grade ratings, relative to a quality of health grade ratings that would be provided by unauthenticated users.

17. The electronic system of claim 15, wherein the medical service provider is a first medical service provider, and wherein the operations further comprise:
accessing information indicative of health grade ratings for a second medical service provider who is associated with the health care entity, with the health grade ratings for the second medical service provider being provided by first authenticated users who are associated with the health care entity;
accessing information indicative of health grade ratings for a third medical service provider who is associated with the health care entity, with the health grade ratings for the third medical service provider being provided by second authenticated users who are associated with the health care entity; and
generating, based on a comparison of the health grade ratings for the second medical service and the health grade ratings for the third medical service, an evaluation of the second medical service provider relative to the third medical service provider, with the evaluation specifying strengths of the second medical service provider relative to strengths of the third medical service provider, with the specified strengths being based on the health grade ratings for the second medical service and the health grade ratings for the third medical service.

18. The electronic system of claim 15, wherein the health grade rating comprises one or more of a patient review, a patient recommendation, a satisfaction rating and an outcome rating;
wherein the outcome rating is indicative of a strength of an assessment of one or more of a pre-operative condition, an operative procedure, and a post-operative condition.

19. The electronic system of claim 15, wherein the health care entity comprises an online patient community, wherein the online patient community comprises medical service providers and users, and wherein the operations further comprise:
restricting access for submission of health grade ratings for medical service providers who are members of the online patient community to users who are members of the online patient community.

20. The electronic system of claim 15, wherein the client device comprises a first client device, and wherein the operations further comprises:
receiving, from a second client device of a searching user, a request to search for a medical service provider associated with one or more predefined attributes that are specified by the searching user as defining an acceptable medical service provider;
identifying, in response to the request to search, a medical service provider that is associated with at least one of the one or more predefined attributes;
identifying, for the identified medical service provider, one or more health grade ratings, with the identified one or more health grade ratings being provided by authenticated users of the health care entity; and
transmitting, to the second client device, information identifying the identified medical service provider and the identified one or more health grade ratings.
